(19) United States
(12) Patent Application Publication
(10) Pub. No.: US 2020/0101746 A1
(43) Pub. Date: Apr. 2, 2020

(54) INK SUPPLY UNIT, INKJET RECORDING APPARATUS, AND MANUFACTURING METHOD

(71) Applicant: CANON KABUSHIKI KAISHA, Tokyo (JP)

(72) Inventors: Yumi Mukoyama, Kawasaki-shi (JP); Tsuyoshi Saeki, Kawasaki-shi (JP); Toshiaki Tokisawa, Kawasaki-shi (JP); Ryoma Arai, Kawasaki-shi (JP); Takashi Abe, Kawasaki-shi (JP)

(21) Appl. No.: 16/570,968

(22) Filed: Sep. 13, 2019

(30) Foreign Application Priority Data
Sep. 28, 2018 (JP) 2018-184611

(51) Int. Cl. B41J 2/175

(52) U.S. Cl. CPC B41J 2/1754; B41J 2/17559; B41J 2/17523

(57) ABSTRACT

An ink supply unit supplying ink from an ink tank to a recording head, includes: a component including a pump by which ink is supplied and having an abutment portion constituted by a laser light absorbing material; a plate having a first surface capable of abutting against the abutment portion, a second surface opposite to the first surface, and a channel forming unit that surrounds an opening passing through the plate from the first surface to the second surface and projects from the second surface; a sealing member that seals the opening; and an ink channel from a first abutment place of a side of the second surface where the abutment portion abuts against the first surface around the opening, and from a second abutment place of the side of the second surface where the sealing member abuts against the channel forming unit.

### BACKGROUND

### Field

The present disclosure relates to an ink supply unit, an inkjet recording apparatus, and a manufacturing method.

### Description of the Related Art

Some inkjet recording apparatuses of the related art have an ink supply unit that supplies ink from an ink tank to a recording head. The ink supply unit is constituted by a channel in which ink flows, and components such as a pump and a valve that control a flow of the ink. Japanese Patent Laid-Open No. 2000-43283 discloses an ink supply unit in which a sealing member, which seals an ink channel, an abutment plate, and components are fastened to a flat plate part in which the ink channel and inlets and outlets of ink to and from the components are formed.

### SUMMARY

According to configurations of Japanese Patent Laid-Open No. 2000-43283, however, in a case where a fastening place increases depending on the number of components, an increase in the number of fastening parts may increase a size of the ink supply unit.

In view of the aforementioned problem, embodiments of a supply unit are provided herein that are capable of achieving a size reduction regardless of the number of components.

In order to solve the aforementioned problem, an ink supply unit according to an aspect of the present disclosure comprises an ink supply unit that supplies ink from an ink tank to a recording head, and includes: a component that includes a pump by which ink is supplied and that has an abutment portion constituted by a laser light absorbing material; a plate that has a first surface capable of abutting against the abutment portion, a second surface opposite to the first surface, and a channel forming unit that surrounds an opening passing through the plate from the first surface to the second surface and projects from the second surface; a sealing member that seals the opening; and an ink channel from a first abutment place of a side of the second surface where the abutment portion abuts against the first surface around the opening, and from a second abutment place of the side of the second surface where the sealing member abuts against the channel forming unit.

Further features of the present disclosure will become apparent from the following description of exemplary embodiments with reference to the attached drawings.

### BRIEF DESCRIPTION OF THE DRAWINGS

FIG. 1 illustrates an inkjet recording apparatus in a standby state.

FIG. 2 illustrates a control configuration of the inkjet recording apparatus.

FIG. 3 illustrates the inkjet recording apparatus in a recording state.

FIG. 4 illustrates the inkjet recording apparatus in a maintenance state.

FIG. 5 is a schematic view illustrating a configuration of an ink supply unit.

FIGS. 6A and 6B are views for explaining a detailed configuration of a recording head.

FIGS. 7A and 7B are perspective views of an ink tank unit and the ink supply unit.

FIGS. 8A and 8B are perspective views of a sub unit.

FIGS. 9A, 9B, and 9C are perspective views for explaining a configuration of an ink channel plate.

FIG. 10 is a perspective view for explaining a configuration of the ink channel plate.

FIG. 11 is a schematic sectional view illustrating how the ink channel plate and components are connected.

FIG. 12 is a schematic sectional view illustrating how an opening of the ink channel plate is sealed.

FIG. 13 is a schematic sectional view illustrating how the opening of the ink channel plate is sealed through a secondary material.

### DESCRIPTION OF THE EMBODIMENTS

Although embodiments of the disclosure will be described below with reference to the drawings, the invention is not limited to the following embodiment and not all combinations of features described in the disclosed embodiments are necessarily essential for the solution to be provided. Note that, the same constituent elements will be given the same reference signs in the following description. Further, relative arrangement, shapes, and the like of constituent elements described in the embodiment are merely examples, and should not be considered as limiting the scope of the invention only to them.

### First Embodiment

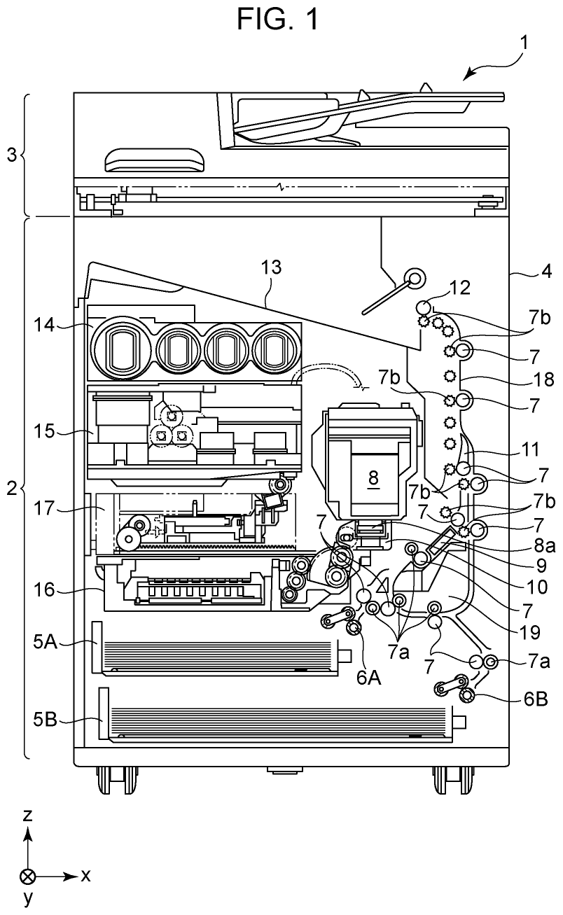

FIG. 1 illustrates an internal configuration of an inkjet recording apparatus (hereinafter, recording apparatus) 1 in the present embodiment. In the figure, hereinafter, an x-direction indicates a horizontal direction, a y-direction (direction perpendicular to a paper surface) indicates a direction in which ejection ports are arrayed in a recording head 8 described later, and a z-direction indicates a vertical direction.

The recording apparatus 1 is a multifunction peripheral including a print unit 2 and a scanner unit 3 and is capable of performing various kinds of processing relating to a recording operation and a reading operation by the print unit 2 and the scanner unit 3 individually or in an interlocking manner. The scanner unit 3 includes an ADF (Automatic Document Feeder) and an FBS (Flat Bed Scanner) and is capable of reading of a document automatically fed by the ADF and reading (scanning) of a document placed on a document table of the FBS by a user. Note that, the present embodiment is the multifunction peripheral having both the print unit 2 and the scanner unit 3, but may be an aspect in which the scanner unit 3 is not included. FIG. 1 illustrates the recording apparatus 1 in a standby state where the recording apparatus 1 performs neither the recording operation nor the reading operation.

In the print unit 2, at a bottom of a case 4 in a vertically downward direction, a first cassette 5A and a second cassette 5B that store a recording medium (cut sheet) S are installed in an attachable and detachable manner. Comparatively small recording media up to an A4 size and comparatively large recording media up to an A3 size are respectively stored in the first cassette 5A and the second cassette 5B in a piled-up manner. In a vicinity of the first cassette 5A, a first feed unit 6A that feeds the stored recording media by separating the recording media one by one is provided. Similarly, in a vicinity of the second cassette 5B, a second feed unit 6B is provided. When the recording operation is performed, the recording medium S is selectively fed from any one of the cassettes.

Conveyance rollers 7, a discharge roller 12, pinch rollers 7a, spurs 7b, a guide 18, an inner guide 19, and a flapper 11 are conveyance mechanisms that guide the recording medium S in a predetermined direction. The conveyance rollers 7 are driving rollers that are arranged on upstream and downstream sides of the recording head 8 and driven by a conveyance motor (not illustrated). The pinch rollers 7a are driven rollers that are arranged on the upstream side of the recording head 8 and nip the recording medium S and rotate together with the conveyance rollers 7. The discharge roller 12 is a driving roller that is arranged at a most downstream part in a conveyance path and driven by a conveyance motor (not illustrated). The spurs 7b are arranged on the downstream side of the recording head 8 and guide the recording medium S in a predetermined direction. A spur 7b that is provided at a position facing a conveyance roller 7 or the discharge roller 12 sandwiches and conveys the recording medium S together with the conveyance roller 7 or the discharge roller 12.

The guide 18 is provided in the conveyance path of the recording medium S and guides the recording medium S in the predetermined direction. The inner guide 19 is a member extending in the y-direction, has a curved side surface, and guides the recording medium S along the side surface. The flapper 11 is a member used to switch the direction in which the recording medium S is conveyed during a two-sided recording operation. A discharge tray 13 is a tray on which the recording medium S discharged by the discharge roller 12 after completion of the recording operation is stacked and retained.

The recording head 8 of the present embodiment is a color inkjet recording head of a full-line type (line head), and a plurality of ejection ports from which ink is ejected in accordance with recording data are arrayed so as to correspond to a width of the recording medium S in the y-direction in FIG. 1. When the recording head 8 is in a standby position illustrated in FIG. 1, an ejection port surface 8a of the recording head 8 is capped by a cap unit 10. A position of the cap unit 10 is also referred to as a capping position. When the recording head 8 performs the recording operation, a direction of the recording head 8 is changed by a print controller 202 described later in such a manner that the ejection port surface 8a faces a platen 9. The platen 9 is constituted by a flat plate extending in the y-direction, and supports the recording medium S, on which the recording operation is performed by the recording head 8, from a back side thereof. The movement of the recording head 8 from the standby position to a recording position will be described in detail later.

An ink tank unit 14 accumulates ink of four colors to be supplied to the recording head 8. An ink supply unit 15 is provided on the way of a channel connecting the ink tank unit 14 and the recording head 8 and adjusts a pressure and a flow rate of ink within the recording head 8 to an appropriate range. The present embodiment adopts an ink supply system of a circulation type so that the ink supply unit 15 adjusts the pressure of the ink supplied to the recording head 8 and the flow rate of the ink collected from the recording head 8 to an appropriate range.

A maintenance unit 16 includes the cap unit 10 and a wiping unit 17 and causes the cap unit 10 and the wiping unit 17 to operate at predetermined timing to perform a maintenance operation for the recording head 8. Details of the maintenance unit 16 will be described later.

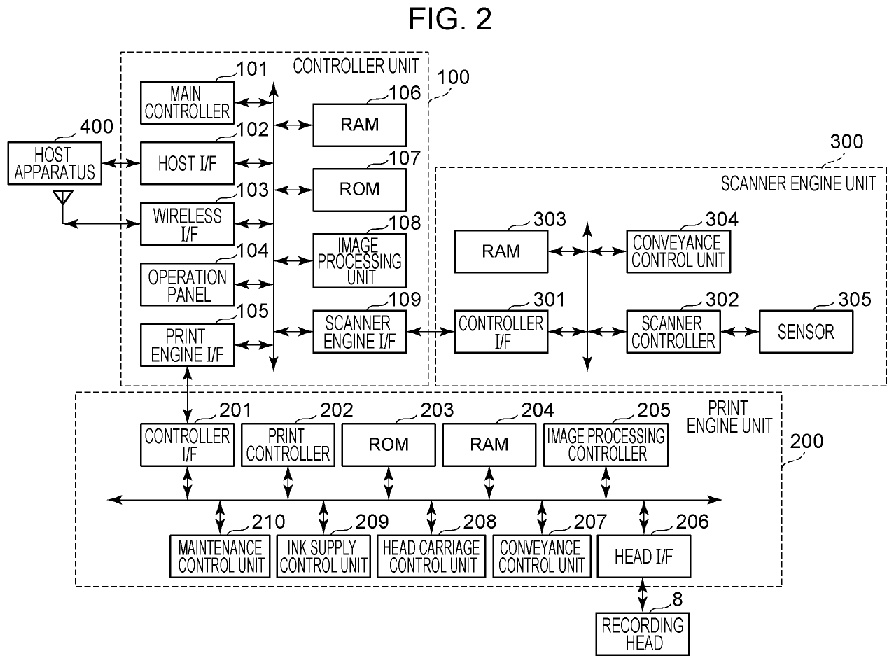

FIG. 2 is a block diagram illustrating a control configuration in the recording apparatus 1. The control configuration mainly includes a print engine unit 200 that comprehensively controls the print unit 2, a scanner engine unit 300 that comprehensively controls the scanner unit 3, and a controller unit 100 that comprehensively controls the entire recording apparatus 1. The print controller 202 controls various mechanisms of the print engine unit 200 in accordance with an instruction from a main controller 101 of the controller unit 100. Various mechanisms of the scanner engine unit 300 are controlled by the main controller 101 of the controller unit 100. Details of the control configuration will be described below.

In the controller unit 100, the main controller 101 constituted by a CPU controls the entire recording apparatus 1 by using a RAM 106 as a work area in accordance with a program and various parameters stored in a ROM 107. For example, when a print job is input from a host apparatus 400 via a host I/F 102 or a wireless I/F 103, an image processing unit 108 performs predetermined image processing for image data, which is received as a recording target, in accordance with an instruction from the main controller 101. Then, the main controller 101 transmits the image data subjected to the image processing to the print engine unit 200 via a print engine I/F 105.

Note that, the recording apparatus 1 may acquire image data from the host apparatus 400 through wireless or wired communication or from an external storage apparatus (such as a USB (Universal Serial Bus) memory) connected to the recording apparatus 1. A communication method for use in the wireless or wired communication is not limited. For example, Wi-Fi (Wireless Fidelity) (registered trademark) or Bluetooth (registered trademark) is applicable as the communication method for use in the wireless communication. Further, USB or the like is applicable as the communication method for use in the wired communication. Further, for example, when a reading command is input from the host apparatus 400, the main controller 101 transmits the command to the scanner unit 3 via a scanner engine I/F 109.

An operation panel 104 is a mechanism for a user to perform input and output for the recording apparatus 1. The user is able to give an instruction as to an operation, such as copying or scanning, to set a printing mode, or to recognize information about the recording apparatus 1 each via the operation panel 104.

In the print engine unit 200, the print controller 202 constituted by a CPU controls various mechanisms of the print unit 2 by using a RAM 204 as a work area in accordance with a program and various parameters stored in a ROM 203. When various commands and image data are received via a controller I/F 201, the print controller (control unit) 202 temporarily saves the image data in the RAM 204. The print controller 202 causes an image processing controller 205 to convert the saved image data into recording data so that the recording head 8 is able to use the recording data in the recording operation.

When the recording data is generated, the print controller 202 causes the recording head 8 to perform the recording operation based on the recording data via a head I/F 206. At this time, the print controller 202 conveys the recording medium S by driving the first feed unit 6A, the second feed unit 6B, the conveyance rollers 7, the discharge roller 12, and the flapper 11 which are illustrated in FIG. 1 via a conveyance control unit 207. In accordance with an instruction from the print controller 202, the recording operation by the recording head 8 is performed by interlocking a conveyance operation of the recording medium S and printing processing is performed.

A head carriage control unit 208 changes the direction and the position of the recording head 8 in accordance with the operation state, such as a maintenance state or a recording state, of the recording apparatus 1. An ink supply control unit 209 controls the ink supply unit 15 so that a pressure of ink supplied to the recording head 8 is adjusted within an appropriate range. A maintenance control unit 210 controls operations of the cap unit 10 and the wiping unit 17 in the maintenance unit 16 at a time of performing the maintenance operation for the recording head 8.

In the scanner engine unit 300, the main controller 101 controls a hardware resource of a scanner controller 302 by using the RAM 106 as a work area in accordance with a program and various parameters stored in the ROM 107. Thereby, various mechanisms included in the scanner unit 3 are controlled. For example, by the main controller 101 controlling the hardware resource within the scanner controller 302 via a controller I/F 301, a document mounted on the ADF by the user is conveyed via a conveyance control unit 304 and read by a sensor 305. Then, the scanner controller 302 saves the read image data in a RAM 303. Note that, the print controller 202 is able to cause the recording head 8 to perform the recording operation based on the image data read by the scanner controller 302 by converting the acquired image data into the recording data as described above.

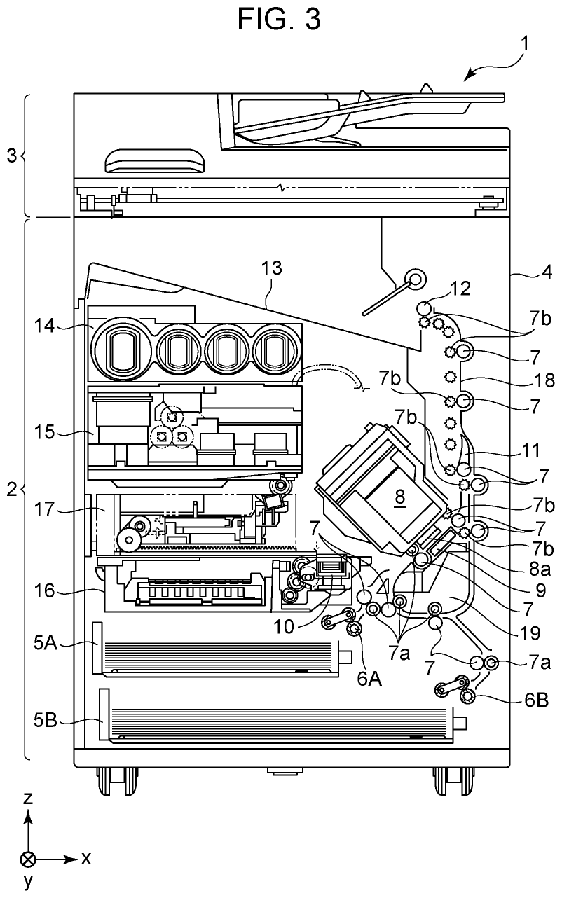

FIG. 3 illustrates the recording apparatus 1 in a recording state. Compared to the standby state illustrated in FIG. 1, the cap unit 10 is separated from the ejection port surface 8a of the recording head 8, and the ejection port surface 8a faces the platen 9. In the present embodiment, a plane of the platen 9 is tilted at about 45 degrees with respect to the horizontal direction, and the ejection port surface 8a of the recording head 8 at the recording position is also tilted at about 45 degrees with respect to the horizontal direction so that a distance between the ejection port surface 8a and the platen 9 is kept at a fixed distance.

To move the recording head 8 from the standby position illustrated in FIG. 1 to the recording position illustrated in FIG. 3, the print controller 202 lowers the cap unit 10 to a retreat position illustrated in FIG. 3 by using the maintenance control unit 210. Thereby, the ejection port surface 8a of the recording head 8 is separated from a cap member 10a. Then, by using the head carriage control unit 208, the print controller 202 rotates the recording head 8 by 45 degrees while lowering a height of the recoding head 8 in the vertical direction so that the ejection port surface 8a faces the platen 9. The print controller 202 performs a process opposite to that described above to move the recording head 8 from the recording position to the standby position after completion of the recording operation.

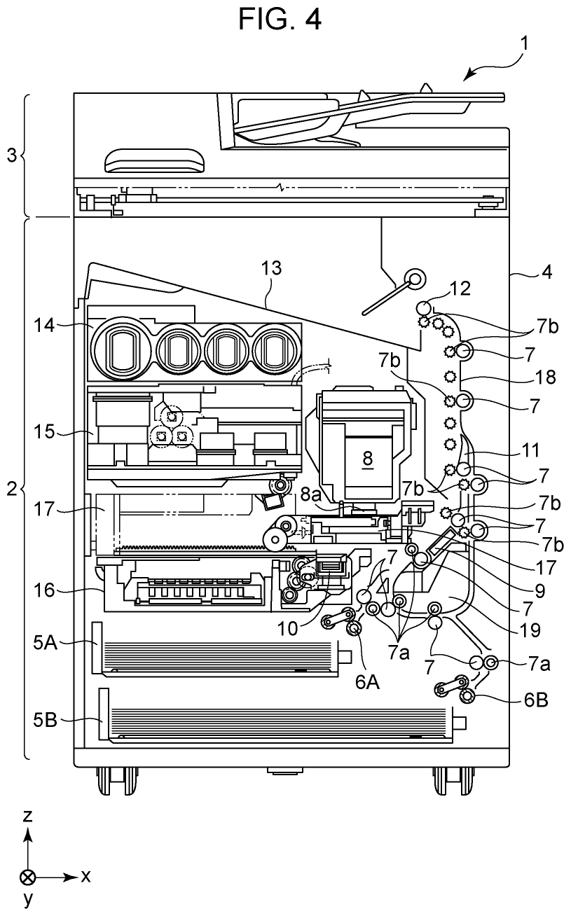

FIG. 4 illustrates the recording apparatus 1 in the maintenance state. To move the recording head 8 from the standby position illustrated in FIG. 1 to a maintenance position illustrated in FIG. 4, the print controller 202 firstly moves the recording head 8 diagonally upward in the vertical direction and moves the cap unit 10 downward in the vertical direction. The print controller 202 then moves the wiping unit 17 in a rightward direction in FIG. 4 from its retreat position. After that, the print controller 202 moves the recording head 8 downward in the vertical direction to move the recording head 8 to the maintenance position at which the maintenance operation is able to be performed.

On the other hand, to move the recording head 8 from the recording position illustrated in FIG. 3 to the maintenance position illustrated in FIG. 4, the print controller 202 firstly moves the recording head 8 upward in the vertical direction while rotating the recording head 8 by about 45 degrees. The print controller 202 then moves the wiping unit 17 in the rightward direction from its retreat position. After that, the print controller 202 moves the recording head 8 downward in the vertical direction to move the recording head 8 to the maintenance position at which the maintenance operation by the maintenance unit 16 is able to be performed.

### <Ink Supply Unit>

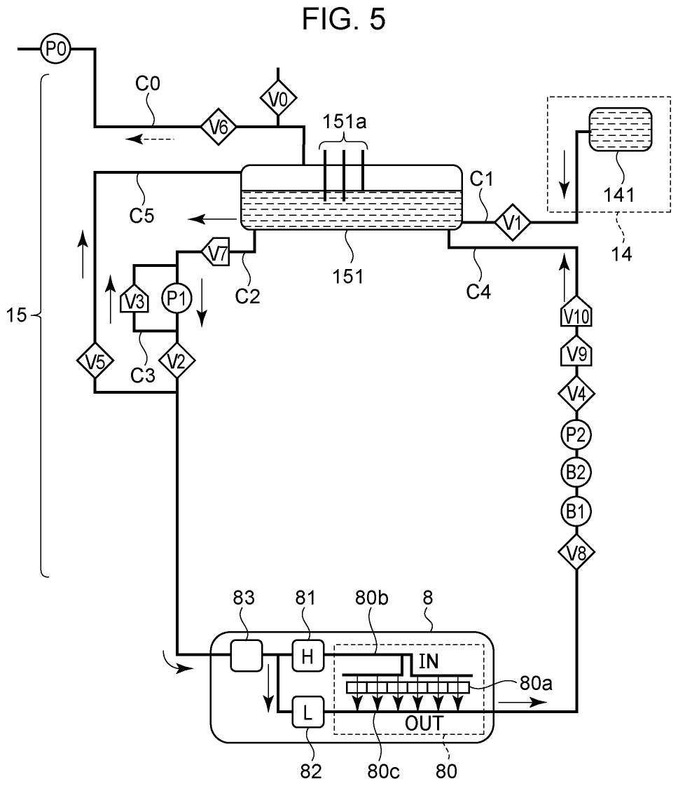

FIG. 5 is a schematic view of the ink supply unit 15 including a peripheral configuration. A channel configuration of an ink circulation system of the present embodiment will be described with reference to FIG. 5. The ink supply unit 15 has a configuration in which ink is supplied from the ink tank unit 14 to the recording head 8. Though FIG. 5 illustrates a configuration relating to ink of one color, a similar configuration is prepared for each of ink colors (for example, cyan, magenta, yellow, and black) in the recording apparatus 1. The ink supply unit 15 is controlled basically by the ink supply control unit 209 illustrated in FIG. 2. Each configuration of the ink supply unit 15 will be described below.

The ink circulates mainly between a sub tank 151 and the recording head 8. In the recording head 8, an ejection operation of the ink is performed on the basis of image data and ink that is not ejected is collected again to the sub tank 151.

The sub tank 151 that stores a predetermined amount of ink is connected to a supply channel C2 for supplying ink to the recording head 8 and a collection channel C4 for collecting ink from the recording head 8. That is, a circulation path through which ink circulates is formed by the sub tank 151, the supply channel C2, the recording head 8, and the collection channel C4. An upper part of the sub tank 151 is connected to an air channel C0 in which the air flows.

The sub tank 151 includes a liquid surface detection unit 151a constituted by a plurality of electrode pins, and the ink supply control unit 209 is able to grasp a height of an ink liquid surface, that is, a remaining amount of ink within the sub tank 151 by detecting whether or not there is a conduction current between the plurality of pins. The sub tank 151 to which ink is supplied has an ink chamber which is in a lower part thereof and in which ink is accumulated and has an air chamber which is in an upper part thereof and in which no ink is accumulated. A decompression pump P0 is a negative pressure generation source for decompressing an inside of a tank of the sub tank 151. An atmosphere open valve V0 is a valve for switching whether or not to cause the inside of the sub tank 151 to communicate with the atmosphere.

A main tank 141 is a tank that stores ink to be supplied to the sub tank 151. The main tank 141 has a configuration attachable to and detachable from a recording apparatus main body. On the way of a tank connection channel C1 that connects the sub tank 151 and the main tank 141, a tank supply valve V1 for switching connection of the sub tank 151 and the main tank 141 is arranged.

When the liquid surface detection unit 151a detects that the amount of ink within the sub tank 151 becomes smaller than a predetermined amount, the ink supply control unit 209 closes the atmosphere open valve V0, a supply valve V2, a collection valve V4, and a head exchange valve V5 and then opens the tank supply valve V1 and a sub tank decompression valve V6. In this state, the ink supply control unit 209 causes the decompression pump P0 to operate. Then, the pressure inside the sub tank 151 becomes negative and ink is supplied from the main tank 141 to the sub tank 151. When the liquid surface detection unit 151a detects that the amount of ink within the sub tank 151 exceeds a predetermined amount, the ink supply control unit 209 closes the tank supply valve V1 and the sub tank decompression valve V6 and stops the decompression pump P0.

The supply channel C2 is a channel for supplying ink from the sub tank 151 to the recording head 8, and on the way of the supply channel C2, a supply pump P1 and the supply valve V2 of a driving type are arranged. During the recording operation, by driving the supply pump P1 in a state where the supply valve V2 is opened, it is possible to supply ink to the recording head 8. An amount of ink ejected by the recording head 8 per unit time fluctuates depending on image data. A flow rate of the supply pump P1 is set so as to be compatible also with a case where the recording head 8 performs an ejection operation in which an amount of ink consumption per unit time reaches a maximum amount, and the supply pump P1 is driven with a driving amount compatible with the flow rate.

Further, a first check valve V7 that prevents ink from flowing backward from the recording head 8 to the sub tank 151 is arranged in the supply channel C2. The first check valve V7 is a valve that allows ink to flow in one direction and regulates a flow of the ink in the opposite direction, and is opened or closed in accordance with a difference in the pressure between the upstream and downstream sides of the valve. Accordingly, the first check valve V7, the supply pump P1, and the supply valve V2 are arranged in this order in the supply channel C2 from a side closer to the sub tank 151.

A relief channel C3 is a channel having one end connected to a part between the first check valve V7 and the supply pump P1 and the other end connected to a part between the supply pump P1 and the supply valve V2, and a relief valve V3 which is a differential pressure valve is provided on the way of the relief channel C3. The relief valve V3 is not opened or closed by a driving mechanism, but is configured to be closed by an urging member such as a spring and opened against an urging force when a predetermined pressure is reached. For example, in a case where an amount of ink supply from the supply pump P1 per unit time is greater than a total value of an ejection amount of the recording head 8 per unit time and a flow rate of a collection pump P2 per unit time, the relief valve V3 is opened in accordance with the pressure applied to the relief valve V3. Consequently, a cyclic channel constituted by a part of the supply channel C2 and the relief channel C3 is formed. Such a configuration of the relief channel C3 is provided so that a pressure of ink supply to the recording head 8 is adjusted in accordance with the amount of ink consumption in the recording head 8 and a pressure in the circulation path is able to be stabilized regardless of image data.

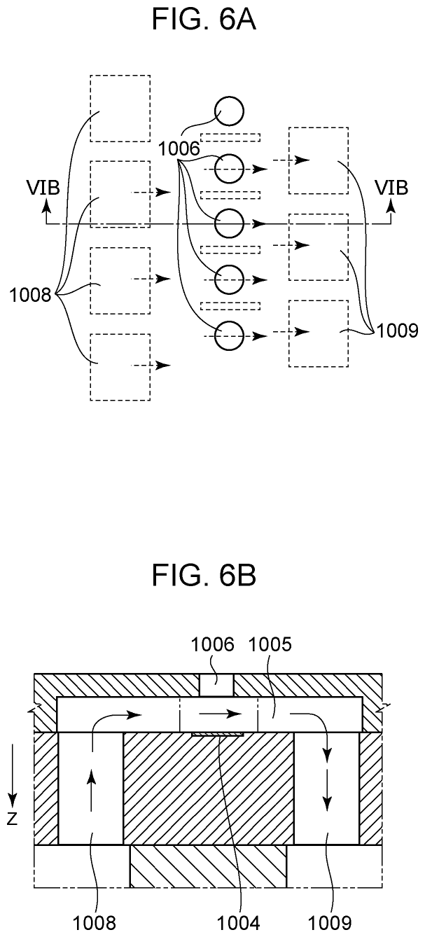

The collection channel C4 is a channel for collecting ink from the recording head 8 to the sub tank 151, and on the way of the collection channel C4, the collection pump P2, the collection valve V4, a buffer chamber shut-off valve V8, a second check valve V9, and a third check valve V10 are arranged. A first buffer chamber B1, a second buffer chamber B2, and the collection pump P2 are further arranged in the collection channel C4. To circulate ink in the circulation path, the collection pump P2 becomes a negative pressure generation source and sucks the ink from the recording head 8. The collection pump P2 is driven so that a suitable difference in pressure is generated between an IN-channel 80b and an OUT-channel 80c in the recording head 8, and the ink is allowed to circulate from the IN-channel 80b to the OUT-channel 80c (refer to FIGS. 6A and 6B). Details of a channel configuration in the recording head 8 will be described later.

The second check valve V9 and the third check valve V10 are valves that prevent ink from flowing backward from the sub tank 151 to the recording head 8. In the circulation path of the present embodiment, the sub tank 151 is arranged above the recording head 8 in the vertical direction (refer to FIG. 1). Therefore, when the supply pump P1 or the collection pump P2 is not driven, ink may flow backward from the sub tank 151 to the recording head 8 due to a water head difference between the sub tank 151 and the recording head 8. In order to prevent such a backflow, in the present embodiment, the second check valve V7 is provided in the collection channel C4. Though two check valves are provided as a reserve in the present embodiment, one or more check valves may be provided.

The collection valve V4 is provided between the collection pump P2 and the second check valve V9, is a valve of a driving type similarly to the supply valve V2, and is opened when the recording operation is performed. Since the collection valve V4 is closed when the recording operation is not performed, the collection valve V4 functions as a check valve that prevents a backflow of ink similarly to the second check valve V9 and the third check valve V10.

The buffer chamber shut-off valve V8 is controlled by the ink supply control unit 209 so as to be closed when an operation of capping the recording head 8 by the cap unit 10 for suction is performed. Such control is performed in order for ink in a channel not to be unnecessarily sucked into the cap unit 10 during the suction. Note that, during the suction by the cap unit 10, the supply valve V2 and the head exchange valve V5 are controlled by the ink supply control unit 209 so as to be closed also in the supply channel C2.

The first buffer chamber B1 and the second buffer chamber B2 are parts used to reduce an effect of expansion and contraction of bubbles included in ink in a channel. The first buffer chamber B1 and the second buffer chamber B2 include a compression spring and a flexible member such as a film, and the film expands and contracts in accordance with extension and contraction of the compression spring. In a case where the bubbles included in the ink in the channel expand or contract due to a temperature change or the like in a state where the ink does not circulate, the first buffer chamber B1 and the second buffer chamber B2 expand or contract in accordance with a volume change of the bubbles. Accordingly, a pressure applied to an ejection port changes due to expansion or contraction of the bubbles so that leakage of the ink or suction of the air from the ejection port is able to be suppressed. Though two buffer chambers for expansion and contraction are provided in the present embodiment, one buffer chamber having both functions may be provided.

A head exchange channel C5 is a channel by which the supply channel C2 and an air chamber (space where no ink is stored) of the sub tank 151 are connected, and on the way of the head exchange channel C5, the head exchange valve V5 is arranged. One end of the head exchange channel C5 is connected to a part in the supply channel C2, which is on the upstream side of the recording head 8 and on the downstream side of the supply valve V2. The other end of the head exchange channel C5 is connected to an upper part of the sub tank 151 in a gravitational direction to communicate with the air chamber inside the sub tank 151. The head exchange channel C5 is used in a case where ink is drawn from the recording head 8 in use, such as a case where the recording head 8 is exchanged or a case where the recording apparatus 1 is transported. The head exchange valve V5 is controlled by the ink supply control unit 209 so as to be closed except for a case where the recording head 8 is filled with ink or a case where ink is drawn from the recording head 8.

Next, the channel configuration in the recording head 8 will be described. The ink supplied through the supply channel C2 to the recording head 8 passes through a filter 83 and is then supplied to a first negative pressure control unit 81 and a second negative pressure control unit 82. In the first negative pressure control unit 81, a control pressure is set to a small negative pressure (negative pressure whose pressure difference from an atmospheric pressure is small). In the second negative pressure control unit 82, a control pressure is set to a larger negative pressure (negative pressure whose pressure difference from the atmospheric pressure is larger) than that of the first negative pressure control unit 81. The pressures in the first negative pressure control unit 81 and the second negative pressure control unit 82 are generated in an appropriate range by driving of the collection pump P2.

In an ink ejection unit 80, a plurality of recording element substrates 80a on each of which a plurality of ejection ports are arrayed are arranged and a long ejection port row is formed. The common supply channel 80b (IN-channel) for guiding ink supplied by the first negative pressure control unit 81 and the common collection channel 80c (OUT-channel) for guiding ink supplied by the second negative pressure control unit 82 also extend in a direction in which the recording element substrates 80a are arrayed.

FIG. 6A is an enlarged schematic plan view illustrating a part of a recording element substrate 80a, and FIG. 6B is a schematic sectional view taken along a line VIb-VIb in FIG. 6A. The recording element substrate 80a includes a pressure chamber 1005 to be filled with ink and ejection ports 1006 for ejecting ink. In the pressure chamber 1005, a recording element 1004 is provided at a position facing an ejection port 1006. Further, the recording element substrate 80a includes, for the ejection ports 1006, a plurality of individual supply channels 1008 connected to the common supply channel 80b and a plurality of individual collection channels 1009 connected to the common collection channel 80c.

The aforementioned configuration generates a flow of ink in which the ink flows from the common supply channel 80b having a relatively small negative pressure (high absolute value of the pressure) into the common collection channel 80c having a relatively large negative pressure (low absolute value of the pressure) in the recording element substrate 80a. More specifically, the ink flows through the common supply channel 80b, an individual supply channel 1008, the pressure chamber 1005, an individual collection channel 1009, and the common collection channel 80c in this order. When ink is ejected by the recording element 1004, a part of the ink that moves from the common supply channel 80b to the common collection channel 80c is ejected from the ejection ports 1006 and thereby discharged outside the recording head 8. On the other hand, ink that is not ejected from the ejection ports 1006 moves through the common collection channel 80c to be collected to the collection channel C4.

When the recording operation is performed, the ink supply control unit 209 closes the tank supply valve V1, the head exchange valve V5, and the sub tank decompression valve V6, opens the atmosphere open valve V0, the supply valve V2, the collection valve V4, and the buffer chamber shut-off valve V8, and drives the supply pump P1 and the collection pump P2. Thereby, a circulation path of the sub tank 151, the supply channel C2, the recording head 8, the collection channel C4, and the sub tank 151 in this order is established. In a case where the amount of ink supply from the supply pump P1 per unit time is greater than the total value of the ejection amount of the recording head 8 per unit time and the flow rate of the collection pump P2 per unit time, ink flows from the supply channel C2 into the relief channel C3. In this manner, the excessively-supplied ink flows into the relief channel C3 so that the flow rate of the ink that flows from the supply channel C2 into the recording head 8 is adjusted.

On the other hand, when the recording operation is not performed, the ink supply control unit 209 stops the supply pump P1 and the collection pump P2 and closes the atmosphere open valve V0, the supply valve V2, the collection valve V4, and the buffer chamber shut-off valve V8. Thereby, the flow of the ink in the recording head 8 stops and a backflow due to a water head difference between the sub tank 151 and the recording head 8 is also suppressed. Further, by closing the atmosphere open valve V0, leakage or evaporation of ink from the sub tank 151 is suppressed.

When ink is drawn from the recording head 8 to the sub tank 151, the ink supply control unit 209 closes the atmosphere open valve V0, the tank supply valve V1, the supply valve V2, the collection valve V4, and the buffer chamber shut-off valve V8, opens the head exchange valve V5, and drives the decompression pump P0. Thereby, the inside of the sub tank 151 is brought into a negative pressure state and the ink in the recording head 8 is collected to the sub tank 151 through the head exchange channel C5. As described above, the head exchange valve V5 is a valve that is closed during a normal recording operation or standby and is opened when the ink is drawn from the recording head 8 to the sub tank 151. Note that, the head exchange valve V5 is opened also when the head exchange channel C5 is filled with ink in a filling process of the recording head 8.

### <Arrangement of Ink Supply Unit>

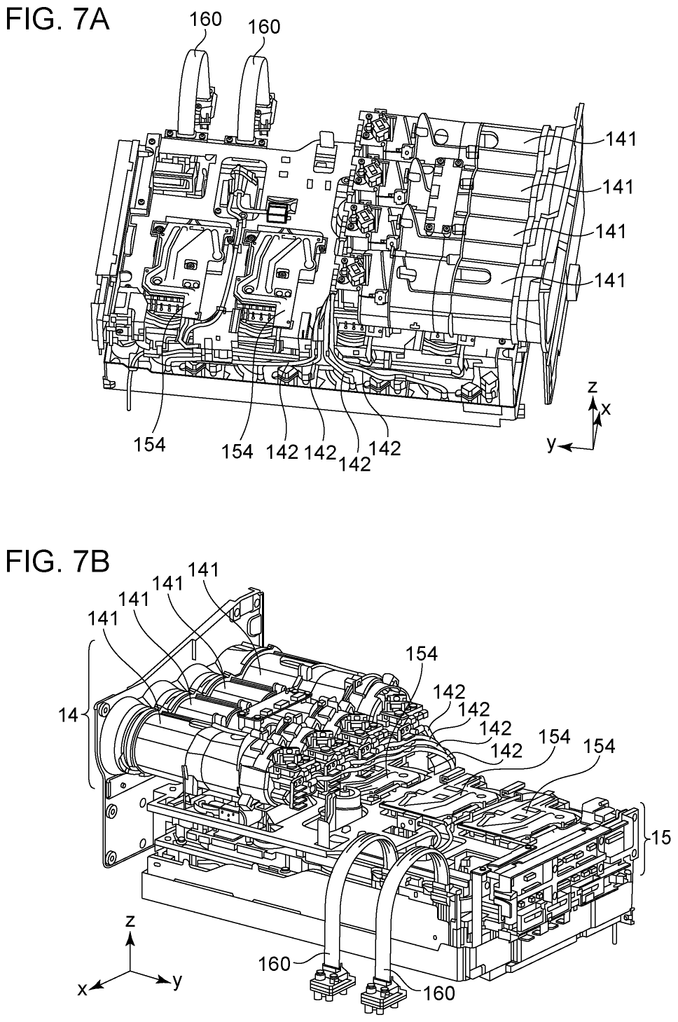

FIGS. 7A and 7B are perspective views including the ink tank unit 14 and the ink supply unit 15. Ink is supplied from the main tank 141 of each color of the ink tank unit 14 to the ink supply unit 15 via a supply tube 142. That is, in the supply tube 142, the tank connection channel C1 for supplying ink from the main tank 141 to the sub tank 151 is formed.

As illustrated in FIG. 7B, the ink supply unit 15 is arranged below the ink tank unit 14 in the gravitational direction. Hereinafter, terms simply called “on” and “below” respectively indicate “on” and “below” in the gravitational direction (z-direction). An arrangement configuration of the ink supply unit 15 will be described later. In the ink supply unit 15, a linkage loop tube 160 is provided in each of the supply channel C2 and the collection channel C4. In the linkage loop tube 160, channels are sectioned in accordance with ink of each color. That is, the supply channel C2 corresponding to each color is formed in one linkage loop tube 160a and the collection channel C4 corresponding to each color is formed in the other linkage loop tube 160b. The linkage loop tubes 160a and 160b are connected to the recording head 8 (not illustrated in FIG. 7A or 7B). An atmosphere communication plate 154 is arranged on the ink supply unit 15.

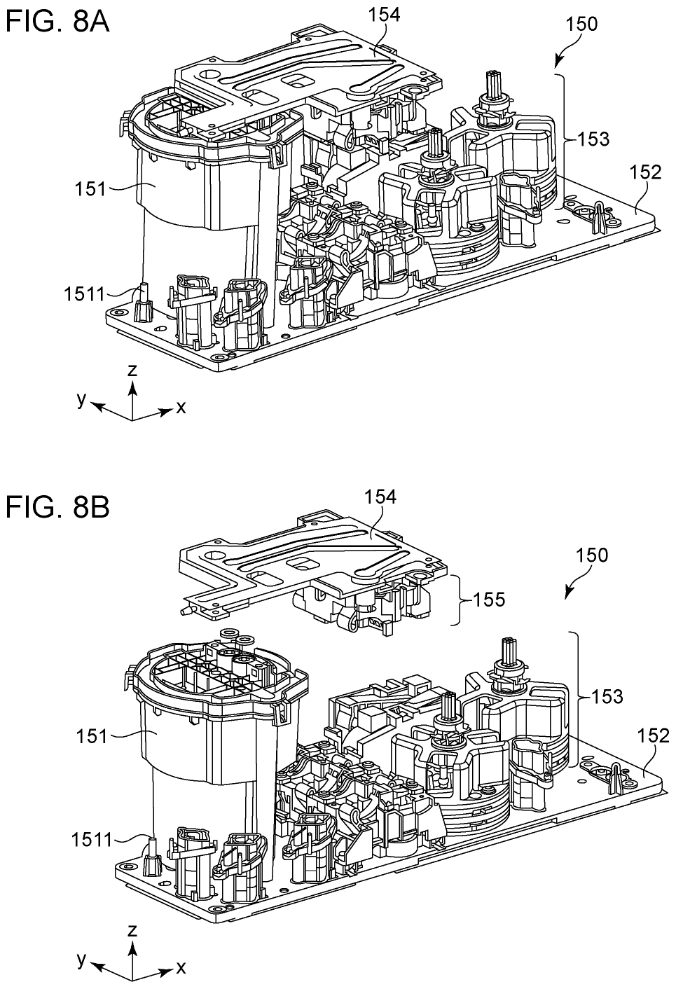

FIG. 8A is a perspective view of a sub unit 150 constituting the ink supply unit 15. FIG. 8B is a perspective view illustrating a state where the atmosphere communication plate 154 of FIG. 8A is separated from the sub unit 150. The sub unit 150 is provided for each ink color. Here, the sub unit 150 corresponding to any ink color is illustrated. The sub unit 150 includes the sub tank 151, an ink channel plate 152 arranged below the sub tank 151, and the atmosphere communication plate 154 arranged on the sub tank 151.

A tube connection unit 1511 that connects supply tubes 142 (refer to FIGS. 7A and 7B) connected to the main tank 141 are arranged on the ink channel plate 152. Ink is supplied to the sub tank 151 through the tank connection channel C1 formed in the ink channel plate 152. Further, in the ink channel plate 152, the supply channel C2 for supplying ink from the sub tank 151 to the recording head 8 and the collection channel C4 for collecting ink from the recording head 8 to the sub tank 151 are formed. In the atmosphere communication plate 154, the air channel C0 in which the air flows is formed.

As illustrated in FIGS. 8A and 8B, in the present embodiment, the sub tank 151 and one or more functional parts (referred to as a first functional part group 153) are arranged on the ink channel plate 152. The first functional part group 153 collectively refers to functional parts acting on a channel of ink. Examples of the functional parts included in the first functional part group 153 include a driving valve for opening and closing the channel by a driving mechanism, a differential pressure valve, a check valve, a circulation pump (the supply pump P1, the collection pump P2) used for circulation, and the buffer chambers B1 and B2. Examples of the driving valve included in the first functional part group 153 include the tank supply valve V1, the supply valve V2, the collection valve V4, the head exchange valve V5, and the buffer chamber shut-off valve V8. An example of the differential pressure valve included in the first functional part group 153 includes the relief valve V3. The check valve is also one kind of the differential pressure valve and the check valve V7, the check valve V9, or the check valve V10 is also included in the differential pressure valve.

In this manner, the first functional part group 153 includes functional parts acting on the tank connection channel C1, the supply channel C2, the relief channel C3, the collection channel C4, or the head exchange channel C5. Note that, a part (not illustrated) where the supply channel C2 is connected to the relief channel C3 and the head exchange channel C5 is provided inside the ink channel plate 152.

Further, one or more functional parts (referred to as a second functional part group 155) are arranged below the atmosphere communication plate 154. The second functional part group 155 collectively refers to functional parts acting on a channel of the air. An example of the functional parts included in the second functional part group 155 includes a driving valve for opening and closing the channel by a driving mechanism. Examples of the driving valve include the atmosphere open valve V0 and the sub tank decompression valve V6. In this manner, the second functional part group 155 includes functional parts acting on the air channel C0.

The sub tank 151, the ink channel plate 152, the atmosphere communication plate 154, the first functional part group 153, and the second functional part group 155 which are illustrated in FIGS. 8A and 8B are provided for each ink color. In the present embodiment, main tanks 141, sub tanks 151, ink channel plates 152, atmosphere communication plates 154, first functional part groups 153, and second functional part groups 155 each may have a common configuration in all the ink colors. When the sub units 150 have a common configuration in all the ink colors, it is possible to reduce cost for the sub units 150 compared to a case where the sub units 150 whose configuration varies for each of the ink colors are prepared. Note that, the functional parts included in the first functional part group 153 and the second functional part group 155 described here are examples and a part of them may not be provided or a functional part other than them may be provided.

### <Channel Plate>

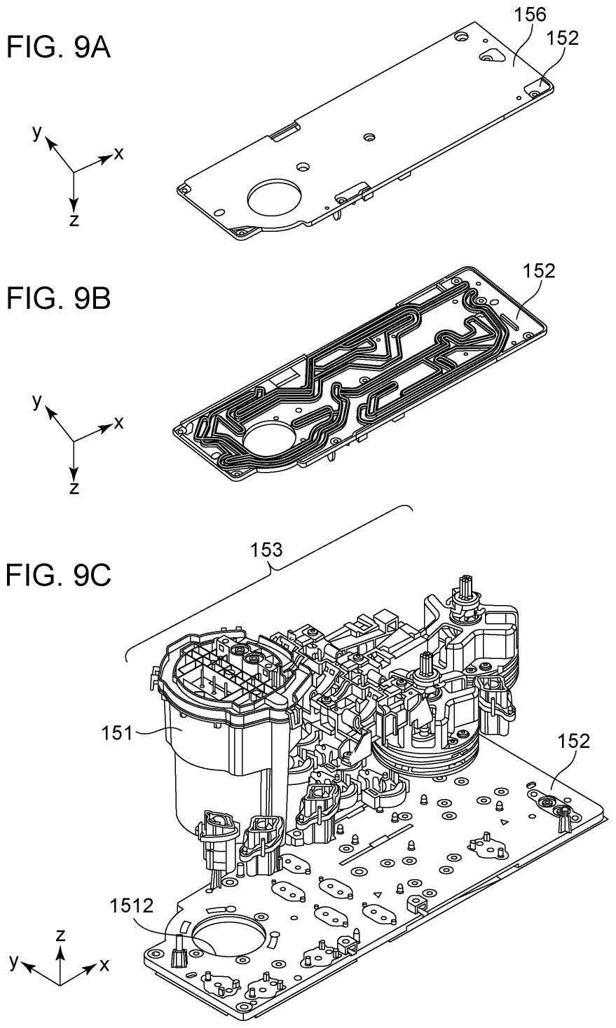

FIGS. 9A to 9C are perspective views for explaining a configuration of the ink channel plate 152. FIG. 9A illustrates the ink channel plate 152 as viewed from below. FIG. 9B is a view in which a channel is visualized by making a sealing member 156 at a top surface of FIG. 9A in a transparent state. FIG. 9C illustrates the ink channel plate 152 as viewed from above. FIG. 9C illustrates a state where the sub tank 151 and the first functional part group 153 which are arranged on the ink channel plate 152 are separated.

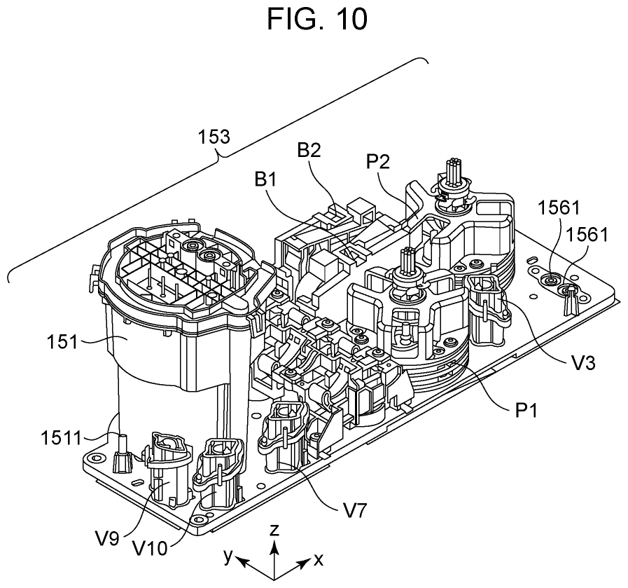

FIG. 10 is a perspective view in which the sub tank 151 and the first functional part group 153 are arranged on the ink channel plate 152. In FIG. 10, parts corresponding to the driving valve, the differential pressure valve, the check valves, the buffer chambers, and the circulation pump which are illustrated in FIG. 5 are denoted by the same reference signs as those in FIG. 5. As illustrated in FIG. 10, the first functional part group 153 is arranged on the ink channel plate 152. The parts of the first functional part group 153 control open and close of a channel and control the flow rate of ink flowing in the channel. In this manner, in the present embodiment, the first functional part group 153 acting on the channel (the tank connection channel C1, the supply channel C2, the relief channel C3, the collection channel C4, or the head exchange channel C5) relating to a flow of ink is arranged in an aggregated manner on the ink channel plate 152.

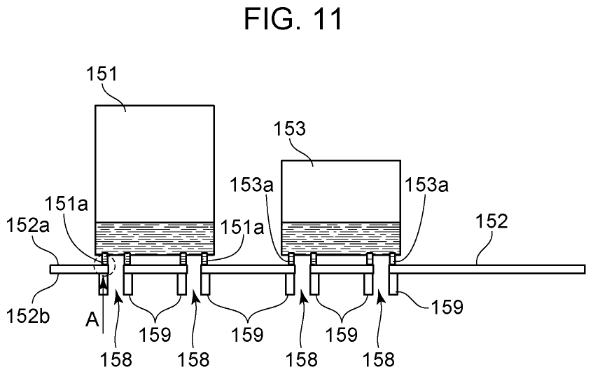

FIG. 11 is a schematic sectional view illustrating how the sub tank 151 and the first functional part group 153 are connected to the ink channel plate 152. Hereinafter, the sub tank 151 and the first functional part group 153 are also referred to as components collectively. The ink channel plate 152 is entirely constituted by a laser light transmitting material, and a surface on which the components are arranged is referred to as a first surface 152a and a surface opposite thereto is referred to as a second surface 152b.

In the sub tank 151, a first projection portion (abutment portion) 151a projecting toward the first surface 152a of the ink channel plate 152 is constituted by a laser light absorbing material. In the present embodiment, not only the first projection portion 151a but also a lower part of the sub tank 151, in which the first projection portion 151a is arranged, is also constituted by a laser light absorbing material.

Similarly, in the first functional part group 153, a second projection portion (abutment portion) 153a projecting toward the first surface 152a of the ink channel plate 152 is constituted by a laser light absorbing material. Similarly to the sub tank 151, a lower part of the first functional part group 153, in which the second projection portion 153a is arranged, is also constituted by a laser light absorbing material in the present embodiment.

In the ink channel plate 152, a plurality of openings 158 that pass through the ink channel plate 152 are provided and channel forming units 159 that are arranged so as to surround the openings 158 and project are provided on a side of the second surface 152b. When the first projection portion 151a and the second projection portion 153a are connected to the openings 158, ink is allowed to communicate between the components and the ink channel plate 152.

In the present embodiment, in a state where the first projection portion 151a and the second projection portion 153a abut against the first surface 152a around the openings 158 of the ink channel plate 152, a place of the abutment is irradiated with laser light from the second surface side in a direction of an arrow A. Thereby, the abutment place indicated by a dotted line in FIG. 11 is thermally welded so that connection is allowed. In this manner, first, the components and the first surface 152a of the ink channel plate 152 are connected by the laser light.

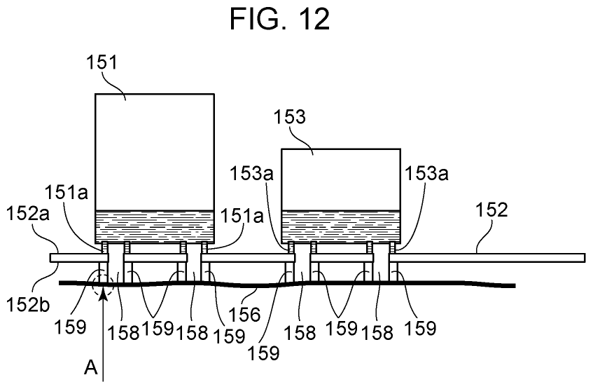

FIG. 12 illustrates how an opening 158 of the ink channel plate 152 is sealed. After the components and the ink channel plate 152 are connected, the sealing member 156 is welded to the channel forming units 159 surrounding the openings 158 so that the openings 158 are sealed. As a result, an ink channel of the ink channel plate 152 is completed. FIG. 12 illustrates an example using a thin film as the sealing member 156.

In the present embodiment, in a state where the channel forming units 159 of the ink channel plate 152 abut against the sealing member 156, an abutment place indicated by a dotted line in FIG. 12 is irradiated with laser light in a direction of the arrow A. Thereby, the ink channel plate 152 and the sealing member 156 are thermally welded and the ink channel is formed.

Note that, a surface of the sealing member 156, which faces the ink channel plate 152, is constituted by a material of the same type as that of the ink channel plate 152. On the other hand, a surface of the sealing member 156, which does not face the ink channel plate 152, is desirably constituted by a material having a high gas barrier property. This makes it possible to suppress inclusion of the air in ink flowing in the channel.

In this manner, the configuration in which the components such as the sub tank 151 and the first functional part group 153 are arranged in an aggregated manner on one surface (first surface 152a) of the ink channel plate 152 enables laser radiation in one direction. It is also possible to seal all the openings 158 of the ink channel plate 152 though the laser radiation in one direction and reduce the number of assembling steps in a manufacturing process. Further, when thermal welding by laser radiation is used as a bonding method, it is possible to reduce contamination with dust or deformation of a part.

### OTHER EMBODIMENTS

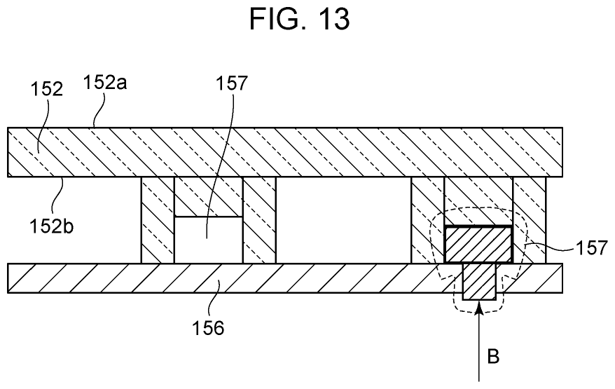

Though the first embodiment indicates an example in which a thin film is used as the sealing member 156, the sealing member 156 may be a member of a substrate shape. A bonding method when the sealing member 156 of a thin substrate shape is used will be described with reference to FIG. 13. Differently from the first embodiment, a groove 157 is provided separately from the opening 158 on the side of the second surface 152b of the ink channel plate 152. The groove 157 is used not to form a channel as does the opening 158 but to connect the sealing member 156 of the substrate shape and the ink channel plate 152. That is, the groove 157 does not communicate with the components.

As illustrated in FIG. 13, a material (secondary material) which is the same as that of the ink channel plate 152 is poured into the groove 157 in a direction of an arrow B by injection molding. Accordingly, the ink channel plate 152 and the sealing member 156 are thermally welded and connected through the secondary material and reliable bonding is able to be performed also when the sealing member 156 has the substrate shape.

Note that, in the example illustrated in FIG. 13, PP (polypropylene) having a transparent or translucent white color as a laser transmission color is used for a plate material and PP (polypropylene) having a black color as a laser absorption color is used for a material of a bottom of the components. Note that, the plate material and the material of the bottom of the components are not limited thereto and it is sufficient that a material having a laser transmission color is used for the plate and a material having a laser absorption color is used for the bottom of the components.

As a first example of a combination, PPE+PS (polyphenylene ether+polystyrene) are used for the plate and PPE+PS (polyphenylene ether+polystyrene) are used for the bottom of the components. Further, as a second example of the combination, PPE+PS (polyphenylene ether+polystyrene) are used for the plate and PPE+PP (polyphenylene ether+polypropylene) are used for the bottom of the components. As a third example of the combination, PP (polypropylene) is used for the plate and PPE+PP (polyphenylene ether+polypropylene) are used for the bottom of the components. In all the examples of the combination, the plate material has a transparent or translucent white color and the material of the bottom of the components has a black color.

That is, according to the disclosure, it is possible to provide a supply unit capable of achieving a size reduction regardless of the number of components.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-184611, filed Sep. 28, 2018, which is hereby incorporated by reference herein in its entirety.

What is claimed is:

1. An ink supply unit that supplies ink from an ink tank to a recording head, the ink supply unit comprising:
a component that includes a pump by which ink is supplied and that has an abutment portion constituted by a laser light absorbing material;
a plate that has a first surface capable of abutting against the abutment portion, a second surface opposite to the first surface, and a channel forming unit that surrounds an opening passing through the plate from the first surface to the second surface and projects from the second surface;
a sealing member that seals the opening; and
an ink channel from a first abutment place of a side of the second surface where the abutment portion abuts against the first surface around the opening, and from a second abutment place of the side of the second surface where the sealing member abuts against the channel forming unit.

2. The ink supply unit according to claim 1, wherein the sealing member is a thin film whose surface facing the plate is constituted by a material of a type identical to that of the plate.

3. The ink supply unit according to claim 1, wherein
the plate has a groove on the side of the second surface,
the sealing member is a substrate constituted by a material of a type identical to that of the plate, and
the plate is connected to the substrate by pouring the material of the identical type into the groove by injection molding.

4. The ink supply unit according to claim 1, wherein the component includes a sub tank that stores ink supplied from the ink tank.

5. The ink supply unit according to claim 4, wherein the component includes a valve driven by a driving mechanism.

6. The ink supply unit according to claim 4, wherein ink circulates between the sub tank and the recording head.

7. The ink supply unit according to claim 1, wherein the plate has a transparent or white color and the abutment portion has a black color.

8. The ink supply unit according to claim 1, wherein the plate has a transparent or translucent white color and the abutment portion has a black color.

9. An inkjet recording apparatus comprising:
an ink tank that stores ink;
a recording head that ejects ink supplied from the ink tank; and
an ink supply unit that supplies ink from the ink tank to the recording head,
the ink supply unit including
a component that includes a pump by which ink is supplied and that has an abutment portion constituted by a laser light absorbing material,
a plate that has a first surface capable of abutting against the abutment portion, a second surface opposite to the first surface, and a channel forming unit that surrounds an opening passing through the plate from the first surface to the second surface and projects from the second surface,
a sealing member that seals the opening, and
an ink channel from a first abutment place of a side of the second surface where the abutment portion abuts against the first surface around the opening, and from a second abutment place of the side of the second surface where the sealing member abuts against the channel forming unit.

10. A manufacturing method of an ink supply unit, the ink supply unit including
a component that includes a pump by which ink is supplied from an ink tank to a recording head and that has an abutment portion constituted by a laser light absorbing material,
a plate that has a first surface capable of abutting against the abutment portion, a second surface opposite to the first surface, and a channel forming unit that surrounds an opening passing through the plate from the first surface to the second surface and projects from the second surface, and
a sealing member that seals the opening,
the manufacturing method comprising:
irradiating, from a side of the second surface, a first abutment place with laser light where the abutment portion abuts against the first surface around the opening; and
irradiating, from the side of the second surface, a second abutment place with laser light where the sealing member abuts against the channel forming unit.
